(19) United States
(12) Patent Application Publication
(10) Pub. No.: US 2005/0259146 A1
(43) Pub. Date: Nov. 24, 2005

(54) Panoramic surveillance device

(75) Inventor: Marc Berdugo, Croissy sur Seine (FR)

Correspondence Address: IP GROUP OF DLA PIPER RUDNICK GRAY CARY US LLP, 1650 MARKET ST, SUITE 4900, PHILADELPHIA, PA, 19103, US

(73) Assignee: Global Vision Holding S.A., a corporation of Luxembourg

(21) Appl. No.: 11/129,018

(22) Filed: May 13, 2005

Related U.S. Application Data
(63) Continuation of application No. PCT/FR03/03397, filed on Nov. 14, 2003.

(30) Foreign Application Priority Data
Nov. 15, 2002 (FR) FR 02/14308
Mar. 27, 2003 (FR) FR 03/03788
Apr. 11, 2003 (FR) FR 03/04551

(51) Int. Cl. H04N 7/18

(52) U.S. Cl. 348/36; 348/143

(57) ABSTRACT

A video surveillance apparatus including an optical device that forms a panoramic image and acquisition of the panoramic image by a camera that transmits video information to a remote viewing station, and a device that acquires an image with a non-panoramic angular opening included in a panoramic photographing field, the orientation of the acquisition device being controlled relative to the field of panoramic optical device as a function of a zone of interest detected in the panoramic image.

### RELATED APPLICATION

This is a continuation of International Application No. PCT/FR2003/003397, with an international filing date of Nov. 14, 2003 (WO 2004/046783 A1, published Jun. 3, 2004), which is based on French Patent Application Nos. 02/14308, filed Nov. 15, 2002, 03/03788, filed Mar. 27, 2003, and 03/04551, filed Apr. 11, 2003.

### FIELD OF THE INVENTION

This invention relates to the area of panoramic photographing equipment, especially for video surveillance.

### BACKGROUND

Various solutions for photographing at a very large angle are known. Solutions using aspherical lenses are not satisfactory because the cost of manufacturing them is very high and the aberrations difficult to correct with software reprocessing.

The use of mirrors that deform with an optical or software anamorphic treatment is also known. By way of example, WO 95/06303 discloses a surveillance system for monitoring a space comprising a single camera and a convex mirror of the dome type. The camera is fixed relative to the mirror in such a manner that at least the majority of the mirror surface is situated in the field of view of the camera. The mirror has a profile such that the radiation coming from the majority of the space is reflected by the dome-type mirror onto the picture plane of the camera. The dome-type mirror is preferably symmetric in a circular manner and its axis of symmetry is aligned relative to the optical axis of the camera. In general, the camera is an electronic camera comprising a sensor with a charge-coupling device at the level of its picture plane. The processed image of the space produced by the camera is displayed on a monitoring screen in the form of a circular or flat image. The system for processing images of the electronic camera can comprise an algorithm for detecting movement intended to generate an alarm in case a movement is detected in the entire predetermined zone of the space.

WO 97/50252 A1 relates to an apparatus for photographing panoramic views that instantaneously captures a panoramic image in 360°. According to one of the embodiments, the photographic apparatus comprises a convex mirror that captures the light of the surrounding panorama, an astigmatic lens that corrects astigmatism, an objective lens that makes the light converge in a single point, a field-flattening lens that makes the images in polar format converge in two-dimensional planar images, and a mechanism for capturing images that captures two-dimensional, optimized annular images of the surrounding panorama. That panoramic photographic device also comprises various systems for displaying and distributing panoramic images. Specifically, those systems comprise a device and a process that permit digital realization of a geometric transformation of the two-dimensional annular image in rectangular projections in such a manner that the panoramic image can be displayed in accordance with traditional processes such as printed images and televised images.

The solution is intended for photographing over 360°, but it produces images that are poor for video surveillance. In fact, the panoramic images do not permit the correct apprehendsion of the details of the field covered and, thus, do not permit realization of an efficient video surveillance.

Solutions of video surveillance using a camera with a normal field that sweeps the volume to be surveyed are also known. That solution produces satisfactory images, but has the disadvantage of leaving non-visualized zones during sweeping. Each zone to be surveilled is visualized only for a very limited time, less than the shadow time.

It would therefore be advantageous to provide a compact panoramic video surveillance equipment that avoids the disadvantages of the prior art.

### SUMMARY OF THE INVENTION

This invention relates to a video surveillance apparatus including an optical device that forms a panoramic image and acquisition of the panoramic image by a camera that transmits video information to a remote viewing station, and a device that acquires an image with a non-panoramic angular opening included in a panoramic photographing field, the orientation of the acquisition device being controlled relative to the field of panoramic optical device as a function of a zone of interest detected in the panoramic image.

### BRIEF DESCRIPTION OF THE DRAWINGS

The invention will be better understood from a reading of the following description that refers to the attached drawings corresponding to a non-limiting example in which:

FIG. 1 shows a view according to a plane in axial section of an exemplary embodiment of a device in accordance with aspects of the invention;

FIG. 2 shows a perspective view of a device in conformity with aspects of the invention;

FIGS. 3 and 4 show views in partial section along a radial plane; and

FIG. 5 shows a view of an image obtained with a device in conformity with aspects of the invention.

### DETAILED DESCRIPTION

It will be appreciated that the following description is intended to refer to specific embodiments of the invention selected for illustration in the drawings and is not intended to define or limit the invention, other than in the appended claims.

The invention relates in a general sense to a piece of equipment for video surveillance comprising optical means for forming a panoramic image and the acquisition of this panoramic image by a camera that transmits video information to a remote viewing station, characterized in that this piece of equipment also comprises means of acquiring an image with a non-panoramic angular opening included in the panoramic photographing field, the orientation of which acquisition means is controlled relative to the field of panoramic optical means as a function of a zone of interest detected in this panoramic image.

The acquisition means is advantageously constituted of an additional mobile camera along at least one axis of rotation. The acquisition means may be constituted of an additional mobile camera along two perpendicular axes of rotation.

The means for forming the panoramic image may comprise at least one mirror with axial symmetry and a curved section and the acquisition means may be constituted of an additional mobile camera along the axis of symmetry of this mirror.

The means for forming the panoramic image preferably comprises a main, annular mirror with a concave section pierced in its center that reflects a primary image on a secondary mirror that is round, concave and with an elliptical profile coaxial to the optical axis, which device comprises a digital image scanner arranged on the optical axis for receiving the secondary image reflected by the secondary mirror.

According to preferred aspects:
the means for forming the panoramic image comprises a diaphragm interposed between the secondary mirror and the image sensor;
the means for forming the panoramic image comprises a circular primary mirror with a hyperbolic section;
the means for forming the panoramic image comprises a concave, elliptical secondary mirror;
the image sensor of the means for forming the panoramic image is arranged in back as far as into a transversal plane intersecting the primary mirror;
the secondary mirror of the means for forming the panoramic image is a mirror with an elliptical section; and
the means for forming the panoramic image comprises a secondary mirror formed by a concave cap with a profile with an elliptical section that ensures the focusing of the primary mirror along a torus onto a sensor.

The means for forming the panoramic image advantageously comprises at least one index hole placed in the field swept by the non-panoramic acquisition means. It may comprise an index hole arranged on an annular crown coaxial with the device for the acquisition of the panoramic image, and may comprise a second index hole placed in a plane containing the axis of the device for the acquisition of the panoramic image.

The equipment may also comprise a viewing station comprising a means for aiming at a zone of interest in the panoramic image and may comprise a circuit for controlling the angular position of the non-panoramic camera as a function of information supplied by the aiming means.

The aiming means may comprise a tactile screen for viewing the panoramic image. The equipment may also comprise a viewing station comprising means for analyzing the panoramic image that delivers information representative of the position of a zone of interest in the panoramic image, and comprises a circuit for controlling the angular position of the non-panoramic camera as a function of information supplied by the analyzing means. The analyzing means may also be a means for detecting local modifications of the panoramic image.

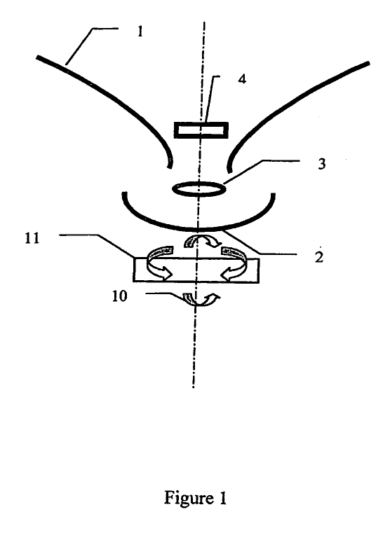

Turning now to the drawings, FIG. 1 shows an exemplary embodiment of a device for photographing panoramic views with a median axis of symmetry 10. The photographing field is cylindrical with an opening of approximately 70° in the radial planes.

The device comprises a primary mirror 1 with an annular form and a concave section. The mirror has a central perforation. Primary mirror 1 reflects light beams toward a secondary mirror 2 arranged coaxially to primary mirror 1 upstream from the photographing field. Secondary mirror 2 is formed by a concave cap with a profile with an elliptical section that ensures the focusing of the primary mirror along a torus onto a sensor 4.

Secondary mirror 2 reflects the light beams to an eyepiece 3 composed of one or several lenses and with an integrated diaphragm. Image sensor 4, e.g., a digital camera, receives the toroidal image adjusted by the eyepiece and delivers a digital signal. The signal is then processed by an image-processing software that ensures the correction of deformations.

The main camera is placed in a transversal plane intersecting primary mirror 1. This allows the realization of a compact device.

An additional camera 11 is arranged under secondary mirror 2 in the blind spot of main mirror 1. This additional camera 11 is a camera with a non-panoramic field. It can be oriented along an axis of rotation coincident with axis of symmetry 10 and along a perpendicular axis of rotation to permit aiming at any zone of the field of the panoramic photographing device. This additional camera 11 supplies a detailed image that permits an enlarged view of a zone of interest on a surveillance screen.

It is thus possible to proceed on the same screen or on independent screens to a global surveillance of a panoramic zone and to the analysis of a particular zone of interest appearing in the panoramic image. The selection of the zone of interest is made manually by an operator charged with the surveillance or automatically.

In the first instance, the operator has an aiming means that allows a zone of interest to be indicated on the screen for viewing the panoramic image. This aiming means can be constituted in a known manner by a mouse, a tactile screen or the like. The superpositioning of a graphic pointer whose position is controlled by actuating the aiming means with a zone of the panoramic image permits calculation of information for piloting additional camera 11. This information controls the orientation according to one or two complementary axes of rotation. The image captured by camera 11 then corresponds to an enlarged view of the zone of interest indicated on the screen for viewing the panoramic image. This image can be viewed on the same screen or on a different screen. Its display does not delete the display of the panoramic image, which allows the operator to continue surveilling the entire zone and detect any new zone of interest.

Locating the relative position of the panoramic image and the enlarged image can be improved by a target appearing in the field that can be visualized by the additional camera. This target can be constituted of one or several opaque or semi-opaque marks corresponding to determined positions. These marks permit a periodic updating of the detailed image by referring to a zone of interest indicated on the panoramic image.

In the automatic solution, the orientation of additional camera 11 is controlled by a circuit for analyzing the panoramic image that detects the zone of interest by image processing. The zones of interest can be determined by a local variation of the intensity or of the characteristics of the panoramic image.

A calculator then determines the barycenter of the zone of interest indicated and calculates the information about the positioning of an additional camera 11 as a function of the position of this barycenter.

A semi-automatic mode includes proposing zones of interest to the operator and a controlling the movement of additional camera 11 only in case of validation by the operator. This proposing of the zone of interest can be represented by the automatic appearance of a graphic pointer or by highlighting the zone of interest. The selection is made by actuating a validation key or by indicating the zone of interest on a tactile screen.

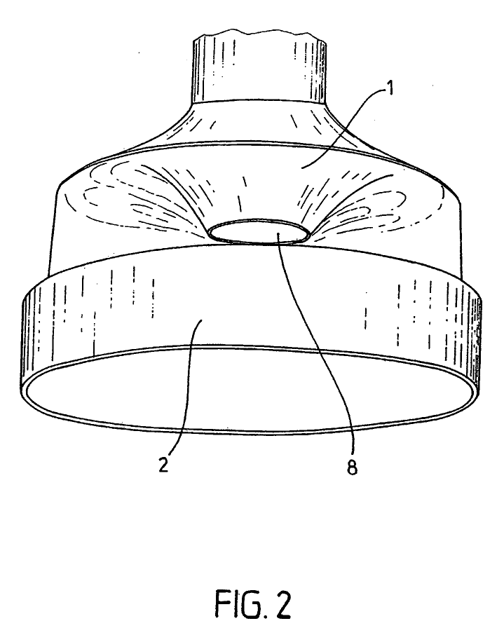

FIG. 2 shows a perspective view of primary mirror 1 with the general shape of a truncated inverted cone generated by the displacement of a concave line along a circular path. Primary mirror 1 is pierced by opening 8. It is placed facing secondary concave mirror 2, whose diameter in the example shown is approximately identical to the diameter of primary mirror 1.

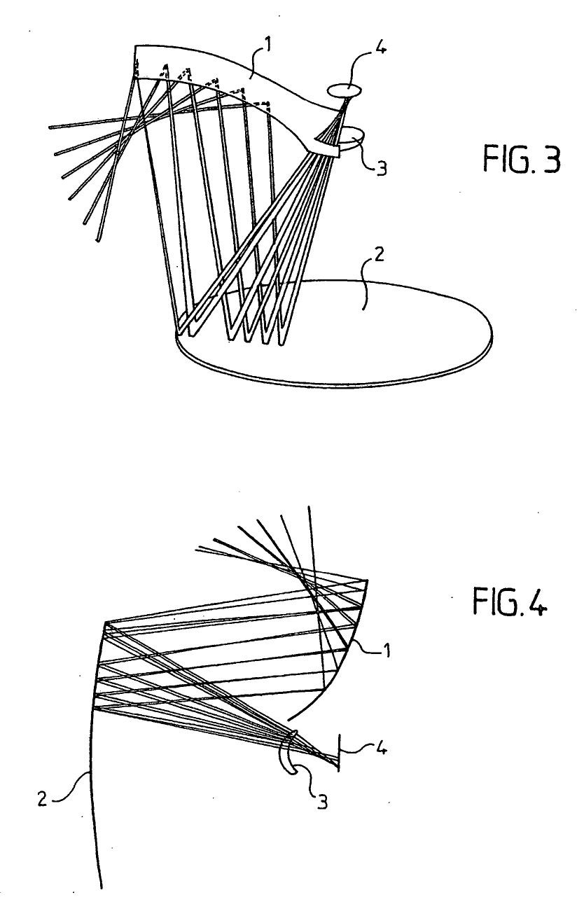

FIGS. 3 and 4 show the optical paths in a device in conformity with the example shown in FIG. 2. The photographing field is formed by a circular crown with an angular opening of approximately 75° C.

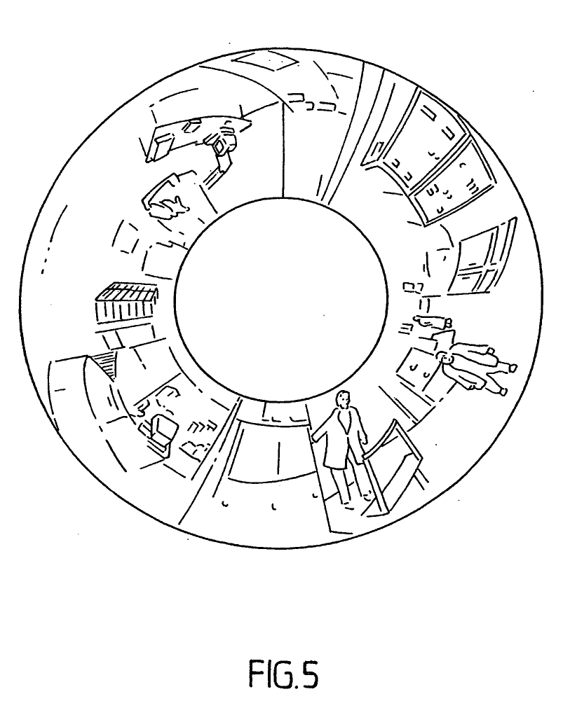

FIG. 5 shows an image recorded with a device in conformity with aspects of the invention.

Although this invention has been described in connection with specific forms thereof, it will be appreciated that a wide variety of equivalents may be substituted for the specified elements described herein without departing from the spirit and scope of this invention as described in the appended claims.

1. A video surveillance apparatus comprising an optical device that forms a panoramic image and acquisition of the panoramic image by a camera that transmits video information to a remote viewing station, and a device that acquires an image with a non-panoramic angular opening included in a panoramic photographing field, the orientation of said acquisition device being controlled relative to the field of panoramic optical device as a function of a zone of interest detected in the panoramic image.

2. The apparatus according to claim 1, wherein the acquisition device further comprises an additional mobile camera along at least one axis of rotation.

3. The apparatus according to claim 1, wherein the acquisition device further comprises an additional mobile camera along two perpendicular axes of rotation.

4. The apparatus according to claim 1, wherein the device that forms the panoramic image comprises at least one mirror with axial symmetry and a curved section and the acquisition device further comprises an additional mobile camera along the axis of symmetry of the mirror.

5. The apparatus according to claim 1, wherein the device that forms the panoramic image comprises a main, substantially annular mirror with a concave section pierced in its center that reflects a primary image on a secondary mirror that is substantially round, concave and with a substantially elliptical profile substantially coaxial to the optical axis and a digital image scanner arranged on the optical axis for receiving the secondary image reflected by the secondary mirror.

6. The apparatus according to claim 5, wherein the device that forms the panoramic image comprises a diaphragm interposed between the secondary mirror and the image sensor.

7. The apparatus according to claim 5, wherein the device that forms the panoramic image comprises a substantially circular primary mirror with a hyperbolic section.

8. The apparatus according to claim 5, wherein the device that forms the panoramic image comprises a substantially concave, elliptical secondary mirror.

9. The apparatus according to claim 5, wherein the image sensor of the device that forms the panoramic image is arranged rearwardly into a transversal plane intersecting the primary mirror.

10. The apparatus according to claim 5, wherein the secondary mirror of the device that forms the panoramic image is a mirror with a substantially elliptical section.

11. The apparatus according to claim 5, wherein the device that forms the panoramic image comprises a secondary mirror formed by a substantially concave cap with a profile with a substantially elliptical section that ensures focusing of the primary mirror along a torus onto a sensor.

12. The apparatus according to claim 1, wherein the device that forms the panoramic image comprises at least one index hole placed in a field swept by the acquisition means.

13. The apparatus according to claim 12, comprising an index hole arranged on a substantially annular crown coaxial with the device that acquires the panoramic image, and comprises a second index hole placed in a plane containing the axis of the device that acquires the panoramic image.

14. The apparatus according to claim 1, further comprising a viewing station comprising an aiming device that aims at a zone of interest in the panoramic image and comprises a circuit for controlling the angular position of the non-panoramic camera as a function of information supplied by the aiming device.

15. The apparatus according to claim 14, wherein the aiming device comprises a tactile screen for viewing the panoramic image.

16. The apparatus according to claim 1, further comprising a viewing station comprising an analyzer for the panoramic image that delivers information representative of the position of a zone of interest in the panoramic image, and comprises a circuit for controlling the angular position of the non-panoramic camera as a function of information supplied by the analyzer.

17. The apparatus according to claim 16, wherein the analyzer is a detector for local modifications of the panoramic image.
